(19) United States
(12) Patent Application Publication
(10) Pub. No.: US 2004/0169637 A1
(43) Pub. Date: Sep. 2, 2004

(54) Input device, information device, and control information generation method

(75) Inventor: Daisuke Sato, Chino-Shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/665,418

(22) Filed: Sep. 22, 2003

(30) Foreign Application Priority Data
Oct. 3, 2002 (JP) 2002-291500

(51) Int. Cl. G09G 5/00

(52) U.S. Cl. 345/156

(57) ABSTRACT

An input device includes: a registered information storage section which stores registered information corresponding to a parameter type; an image capture section which captures an image of a detection object; an image comparison section which compares the image of the detection object captured by the image capture section with the registered information stored in the registered information storage section; a movement detection section which detects movement of the detection object by using the image of the detection object when it is determined that the registered information storage section stores the registered information corresponding to the image of the detection object according to a result of comparison by the image comparison section; and a control information output section which outputs control information corresponding to the parameter type associated with the registered information corresponding to the image of the detection object based on a detection result of the movement detection section.

Japanese Patent Application No. 2002-291500 filed on Oct. 3, 2002, is hereby incorporated by reference in its entirety.

### BACKGROUND OF THE INVENTION

The present invention relates to an input device, an information device including the same, and a control information generation method.

An input device is used as an operating section of an electronic instrument (information instrument or information device). For example, when the user operates the input device, a pointer displayed in a display section is moved or an image of the display section is scrolled in the electronic instrument by using control information (operation information) output from the input device. It is necessary that the input device not decrease operability of the user.

### BRIEF SUMMARY OF THE INVENTION

One aspect of the present invention relates to an input device comprising:

an image capture section which captures an image of a detection object;

an image comparison section which compares the image of the detection object captured by the image capture section with registered information;

a movement detection section which detects movement of the detection object by using the image of the detection object when it is determined that the registered information includes information corresponding to the image of the detection object according to a result of comparison by the image comparison section; and

a control information output section which outputs control information corresponding to a parameter type associated with the registered information corresponding to the image of the detection object based on a detection result of the movement detection section.

Another aspect of the present invention relates to an input device comprising:

a registered information storage section which stores registered information corresponding to a parameter type;

an image capture section which captures an image of a detection object;

an image comparison section which compares the image of the detection object captured by the image capture section with the registered information stored in the registered information storage section;

a movement detection section which detects movement of the detection object by using the image of the detection object when it is determined that the registered information storage section stores the registered information corresponding to the image of the detection object according to a result of comparison by the image comparison section; and

a control information output section which outputs control information corresponding to the parameter type associated with the registered information corresponding to the image of the detection object based on a detection result of the movement detection section.

A further aspect of the present invention relates to an information device comprising the above input device, and a processing section which performs control processing based on the control information from the input device.

A still further aspect of the present invention relates to a control information generation method for generating control information by using a captured image of a detection object, the control information generation method comprising:

searching information corresponding to an image of the detection object in registered information stored corresponding to a parameter type by using the image of the detection object;

detecting movement of the detection object by using the image of the detection object when it is determined that the information corresponding to the image of the detection object is included in the registered information and;

generating the control information corresponding to the parameter type associated with the registered information corresponding to the image of the detection object based on a detection result for the movement of the detection object.

### BRIEF DESCRIPTION OF THE SEVERAL VIEWS OF THE DRAWING

FIG. 1 is a block diagram showing a configuration of an input device in an embodiment of the present invention.

FIG. 2 shows an outline of registered information in this embodiment of the present invention.

FIG. 3 is illustrative of control information in six-axis directions.

FIG. 4 is an external configuration diagram showing an outline of an input device using a fingerprint sensor.

FIG. 5 is a block diagram showing a hardware configuration example of an input device.

FIG. 6 is a circuit diagram showing a configuration of an example of a fingerprint sensor.

FIG. 7 is a cross-sectional view showing a capacitance detection element.

FIG. 8 is an equivalent circuit diagram of a capacitance detection element when a ridge of a fingerprint is in contact with the capacitance detection dielectric film.

FIG. 9 is an equivalent circuit diagram of a capacitance detection element when a valley of a fingerprint faces the capacitance detection dielectric film.

FIGS. 10A and 10B are diagrams illustrating examples of feature points of a fingerprint.

FIG. 11 shows an example of the content of registered information in an embodiment of the present invention.

FIG. 12 is a flowchart showing an example of verification processing of an input device.

FIG. 13 is a flowchart showing the first half of an example of a processing flow of an input device.

FIG. 14 is a flowchart showing the second half of an example of a processing flow of an input device.

FIG. 15 is a flowchart showing an example of registration processing of an input device.

FIG. 16 is illustrative of a method for specifying the position of a fingerprint image in a detection area of a fingerprint sensor.

FIG. 17 shows a movement detection principle using feature points of a fingerprint image.

FIG. 18 is illustrative of the center of gravity of a fingerprint image.

FIG. 19 shows another example of the content of registered information in this embodiment of the present invention.

FIG. 20 is a block diagram showing a configuration example of an IC card.

### DETAILED DESCRIPTION OF THE EMBODIMENT

Embodiments of the present invention are described below in detail with reference to the drawings. Note that the embodiments described hereunder do not in any way limit the scope of the invention defined by the claims laid out herein. Note also that all of the elements described below should not be taken as essential requirements for the present invention.

An input device provided with improved operability when indicating an arbitrary position in a three-dimensional space has been proposed. In this input device, a reference point is set. In the case where the indicated position is not displayed on the screen, the viewpoint is moved by combination of movement around the reference point and movement along a straight line which connects the reference point with the viewpoint, and the three-dimensional space is regenerated (displayed) from the viewpoint after the movement. In the case where the indicated position appears on the screen, a cursor is moved on the screen (Japanese Patent Application Laid-open No. 5-40571, for example). In this input device, the above operation makes it unnecessary to perform the operation in the six-axis directions.

However, it is difficult to apply the input device disclosed in Japanese Patent Application Laid-open No. 5-40571 to a portable information instrument due to the configuration of the position input section for specifying the position. Even if the size of the configuration of the position input section is reduced, since the operator cannot intuitively perform the operation in the three-dimensional space, it is difficult to improve operability unless the operator acquires skill at the operation method.

It is desirable that the above-described input device be applied not only to a three-dimensional CAD device or a virtual reality experience device which performs advanced information processing, but also to a portable telephone or a PDA. Therefore, the input device must have a configuration which enables a battery-driven operation and reduction of the size.

According to the following embodiments, an input device which is extremely small and lightweight and is capable of further improving operability, an information device, and a control information generation method can be provided.

The embodiments of the present invention are described below in detail with reference to the drawings.

1. Input Device

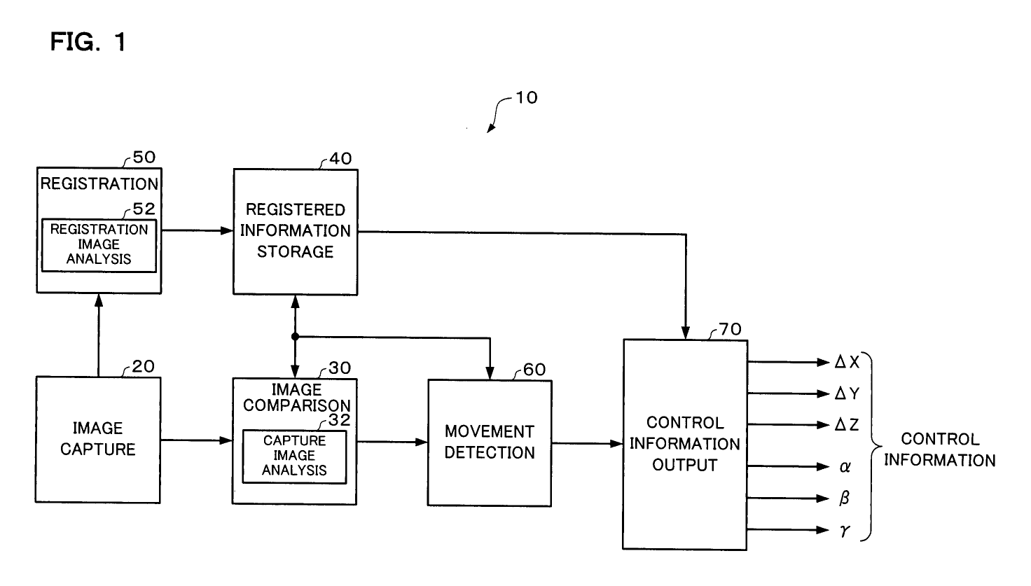

FIG. 1 shows an outline of a configuration of an input device in the this embodiment. An input device 10 in the this embodiment is capable of searching registered information corresponding to a captured image from one or more pieces of registered information, and outputting control information (operation information) in one of the six-axis directions associated with the searched registered information. The input device 10 includes an image capture section 20, an image comparison section 30, a registered information storage section 40, a registration section 50, a movement detection section 60, and a control information output section 70.

The image capture section 20 captures an image of a two-dimensional or three-dimensional detection object moved by the user as two-dimensional information through a detection surface (sensor surface), and generates image information in each frame.

The image comparison section 30 compares the registered information registered in the registered information storage section 40 with the image captured by the image capture section 20 to search the registered information corresponding to the captured image. In more detail, the image comparison section 30 analyzes the image captured by the image capture section 20, and detects whether or not the registered information corresponding to the captured image is included in the registered information registered in the registered information storage section 40 by using the analysis result. The image comparison section 30 may include a capture image analysis section 32 in order to reduce the load of the image comparison processing. The capture image analysis section 32 analyzes the image of the detection object captured by the image capture section 20, and calculates a feature point or the center of gravity of the image or information equivalent to the feature point or the center of gravity. The feature point used herein refers to a position (region) characteristic of the image which can be referred to in order to specify the moving distance, moving direction, or rotation angle between two images by comparing the two images. The center of gravity used herein refers to the center position of the area of the image.

The registered information storage section 40 stores one or more pieces of registered information. In more detail, the registered information storage section 40 stores the registered information and a parameter type associated with the registered information before the comparison processing of the image comparison section 30. The parameter type is information for determining to output any one of a plurality of pieces of control information. The registered information stored in the registered information storage section 40 is registered by the registration section 50 for each parameter type. The registered information storage section 40 may store the feature point of the image or the like as the registered information in order to reduce the load of the image comparison processing. Therefore, the registration section 50 may include a registered image analysis section 52. The registered image analysis section 52 may calculate the feature point or the center of gravity of the image of the detection object captured by the image capture section 20, or information equivalent to the feature point or the center of gravity.

If the image of the detection object captured by the image capture section 20 is verified by the image comparison section 30 by using the registered information stored in the registered information storage section 40, the movement detection section 60 detects the movement of the detection object by using the image of the detection object. In more detail, if the image comparison section 30 compares the registered information stored in the registered information storage section 40 with the image of the detection object captured by the image capture section 20, and determining that the registered information corresponding to the captured image of the detection object is included in the registered information storage section 40, the movement detection section 60 detects the movement of the detection object based on the change in the image of the detection object.

The control information output section 70 outputs the control information in the control direction corresponding to the parameter type associated with the registered information corresponding to the image of the detection object stored in the registered information storage section 40 corresponding to the moving amount detected by the movement detection section 60. The control information is control information in at least one of the six-axis directions.

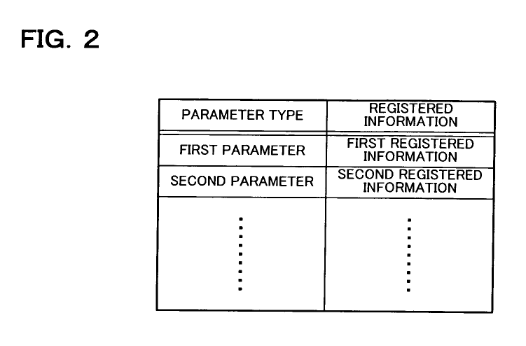

FIG. 2 schematically shows an example of a structure of the registered information stored in the registered information storage section. The registered information is registered by the registration section 50 before the comparison processing. Each piece of the registered information is registered corresponding to the parameter type. The input device 10 outputs the control information in the control direction corresponding to the parameter type. For example, first registered information is registered while being associated with a first parameter. In this case, if the captured image is compared with each piece of the registered information and it is determined that the first registered information corresponds to the image, the control information in the control direction corresponding to the first parameter is output corresponding to the moving amount detected by using the captured image.

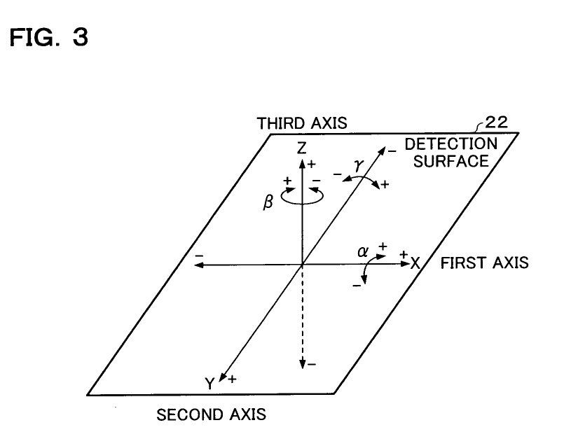

FIG. 3 is illustrative of showing the control information in the six-axis directions. The control information in the six-axis directions is information indicated for the six-axis directions including positions X and Y in the X axis and Y axis (first axis and second axis) directions which intersect at right angles on a detection surface (sensor surface) 22 of the image capture section 20 (or on a plane parallel to the detection surface), a position Z in the Z axis (third axis) direction perpendicular to the detection surface, a rotation angle α around the X axis, a rotation angle γ around the Y axis, and a rotation angle β around the Z axis. As shown in FIG. 3, a (+) direction and a (−) direction are specified for each of the position X in the X axis direction, the position Y in the Y axis direction, the position Z in the Z axis direction, the rotation angle α around the X axis, the rotation angle β around the Z axis, and the rotation angle γ around the Y axis.

The input device is described below in detail. The input device described below uses a fingerprint sensor. However, the present invention is not limited thereto.

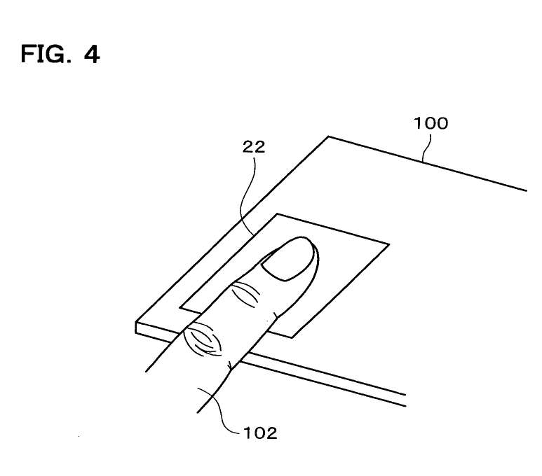

FIG. 4 shows an outline of an external configuration of the input device using a fingerprint sensor. FIG. 4 shows the case where the input device in the this embodiment is mounted on an IC card (information device in a broad sense) 100. The IC card 100 includes a CPU and a memory device. This enables the IC card 100 to be provided with improved security protection and to store a large amount of advanced information by information processing. Information processing in which various types of operation of the user are reflected can be performed by using an extremely small and lightweight configuration by using the input device in the this embodiment.

In FIG. 4, a fingerprint image is captured by allowing a finger (detection object in a broad sense) 102 of the user on which a fingerprint pattern is formed to come in contact with the detection surface 22 of the fingerprint sensor as the input device. The control information corresponding to the movement of the finger 102 by the user in the six-axis directions detected in the three-dimensional space specified on the detection surface 22 is output. Processing based on the control information is performed in the IC card 100. In the case where a liquid crystal panel is provided in the IC card 100, display control such as movement of a pointer displayed on the liquid crystal panel or scrolling of the display image is performed. In the case where the input device is applied to a three-dimensional CAD device, rotation of the object of operation or movement of the viewpoint is controlled.

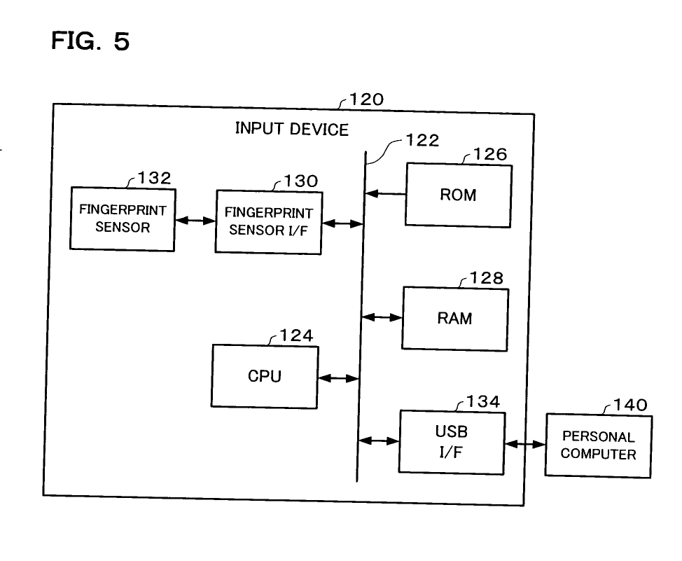

FIG. 5 shows a hardware configuration example of the input device. In an input device 120, a CPU 124, a ROM 126, a RAM 128, and a fingerprint sensor interface (I/F) circuit 130 are connected with a bus 122. A fingerprint sensor 132 is connected with the fingerprint sensor I/F circuit 130. A USB I/F circuit 134 is connected with the bus 122. The USB I/F circuit 134 is connected with a host device or a peripheral device defined in the USB standard such as a personal computer 140 outside the input device.

The function of the image capture section 20 shown in FIG. 1 is mainly realized by the fingerprint sensor 132 and the fingerprint sensor I/F circuit 130. A fingerprint image captured by the fingerprint sensor 132 is stored in the RAM 128 through the fingerprint sensor I/F circuit 130. The functions of the image comparison section 30 including the capture image analysis section 32, the registration section 50 including the registered image analysis section 52, the movement detection section 60, and the control information output section 70 shown in FIG. 1 are realized by the CPU 124 and a software program stored in the ROM 126 or RAM 128. The function of the registered information storage section 40 shown in FIG. 1 is realized by the RAM 128.

1.1 Fingerprint Sensor

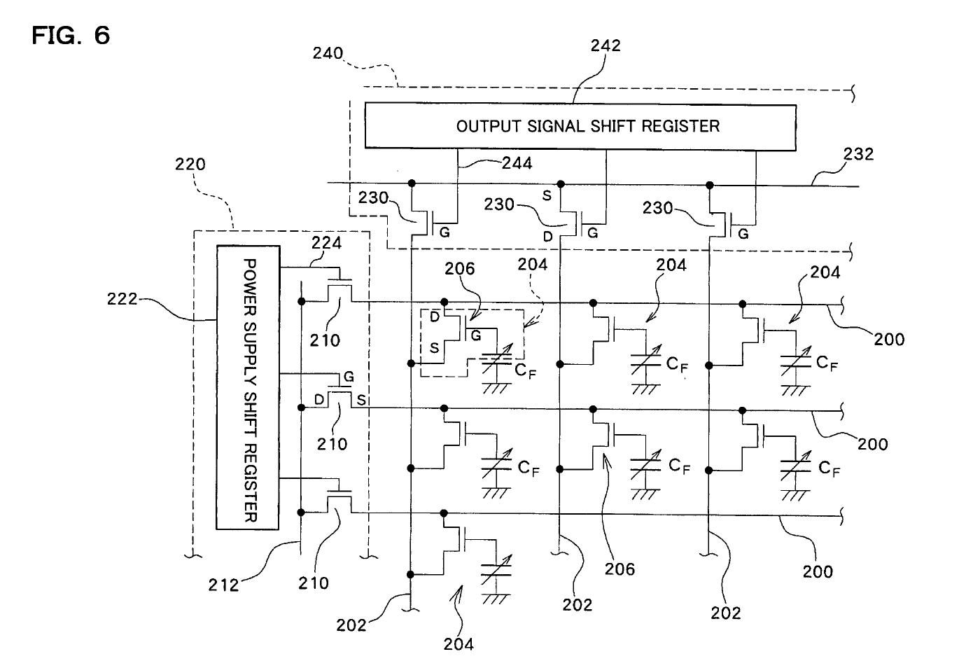

FIG. 6 shows an example of the fingerprint sensor 132. In FIG. 6, the fingerprint sensor 132 includes M (M is an integer of two or more) power supply lines 200 and N (N is an integer of two or more) output lines 202. A capacitance detection element 204 is provided at each intersecting point of the M power supply lines 200 and the N output lines 202. The capacitance detection element 204 shown in FIG. 6 is illustrated as a closed circuit when a finger is in contact with the capacitance detection element 204. The capacitance detection element 204 includes a variable capacitor C_{F} of which the capacitance is changed depending on a ridge/valley pattern of a fingerprint, and a signal amplification element such as a signal amplification MIS thin film semiconductor device (hereinafter abbreviated as “signal amplification TFT”) 206. If a finger is not in contact with the capacitance detection element 204, a grounding side of the variable capacitor C_{F} is in an open state. The variable capacitor C_{F} is described later.

The M power supply lines 200 are connected with drains D of the N signal amplification TFTs 206 arranged along the corresponding row. The M power supply lines 200 are connected with a common power supply line 212 through M power supply pass gates 210. Specifically, the power supply pass gate 210 is formed by using a MIS thin film semiconductor device. A source S of the power supply pass gate 210 is connected with the power supply line 200, and a drain D of the power supply pass gate 210 is connected with the common power supply line 212. A power supply shift register 222 is provided to a power supply select circuit 220 in addition to the M power supply pass gates 210 and the common power supply line 212. A gate G of each of the M power supply pass gates 210 is connected with a power supply select output line 224 of the power supply shift register 222.

The N output lines 202 are connected with sources S of the N signal amplification TFTs 206 arranged along the corresponding column. The N output lines 202 are connected with a common output line 232 through N output signal pass gates 230. Specifically, the output signal pass gate 230 is formed by using an MIS thin film semiconductor device. A drain D of the output signal pass gate 230 is connected with the output line 202, and a source S of the output signal pass gate 230 is connected with the common output line 232. An output signal shift register 242 is provided to an output signal select circuit 240 in addition to the N output signal pass gates 230 and the common output line 232. A gate G of the output signal pass gate 230 is connected with an output select output line 244 of the output signal shift register 242.

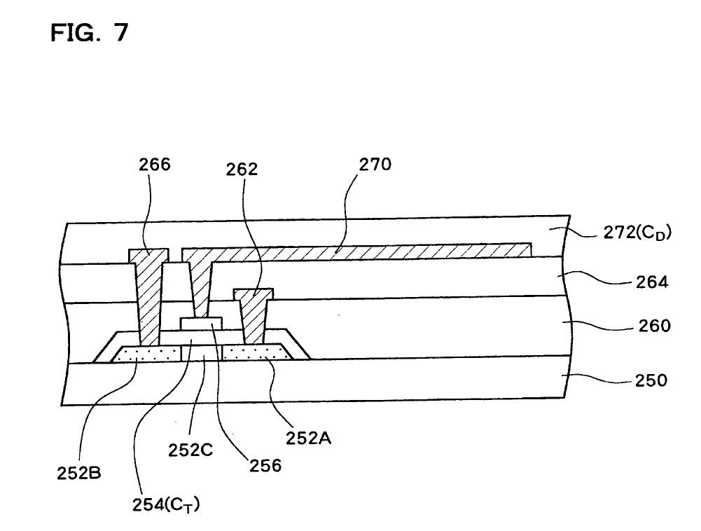

FIG. 7 is a cross-sectional view showing the capacitance detection element 204 shown in FIG. 6. FIG. 7 shows a state in which a finger is not in contact with the capacitance detection element 204. The capacitance detection element 204 includes a signal detection element 208 in addition to the signal amplification TFT 206 which is the signal amplification element.

In FIG. 7, a semiconductor film 252 including a source region 252A, a drain region 252B, and a channel region 252C is formed on an insulating layer 250. A gate insulating film 254 is formed on the semiconductor film 252. A gate electrode 256 is formed in a region which faces the channel region 252C with the gate insulating film 254 interposed therebetween. The semiconductor film 252, the gate insulating film 254, and the gate electrode 256 make up the signal amplification TFT 206. The power supply pass gate 210 and the output signal pass gate 230 are formed in the same manner as the signal amplification TFT 206.

The signal amplification TFT 206 is covered with a first interlayer dielectric 260. A first interconnect layer 262 corresponding to the output line 202 shown in FIG. 6 is formed on the first interlayer dielectric 260. The first interconnect layer 262 is connected with the source region 252A of the signal amplification TFT 206.

The first interconnect layer 262 is covered with a second interlayer dielectric 264. A second interconnect layer 266 corresponding to the power supply line 200 shown in FIG. 6 is formed on the second interlayer dielectric 264. The second interconnect layer 266 is connected with the drain region 252B of the signal amplification TFT 206. As another structure differing from the structure shown in FIG. 7, the second interconnect layer 266 may be formed on the first interlayer dielectric 260, and the first interconnect layer 262 may be formed on the second interlayer dielectric 264.

A capacitance detection electrode 270 is formed on the second interlayer dielectric 264. A capacitance detection dielectric film 272 is formed to cover the capacitance detection electrode 270. The capacitance detection dielectric film 272 is located on the outermost surface of the fingerprint sensor 132 and functions as a protective film. A finger comes in contact with the capacitance detection dielectric film 272. The signal detection element 208 is made up of the capacitance detection electrode 270 and the capacitance detection dielectric film 272.

1.1.1 Fingerprint Detection Operation

A fingerprint is detected by allowing a finger to come in contact with the capacitance detection dielectric film 272 shown in FIG. 7. A start switch (pressure-sensitive switch, for example) 42 of the fingerprint sensor 132 is operated to allow a power supply inside the input device 120 to be operated, whereby power is automatically supplied to the fingerprint sensor 132. The input device 120 maybe provided to the personal computer 140, and power may be supplied from a power supply section of the personal computer 140.

In the this embodiment, a signal is sequentially removed from the M×N capacitance detection elements 204 by providing a power supply voltage to one of the M power supply lines 200 shown in FIG. 6 and detecting a signal from one of the N output lines 202.

The fingerprint detection operation is roughly divided into (1) a case where a ridge (projecting section) of the fingerprint pattern comes in contact with the capacitance detection dielectric film 272, and (2) a case where a valley (recess section) of the fingerprint pattern faces the capacitance detection dielectric film 272.

(1) When Ridge (Projecting Section) of Fingerprint Pattern Comes in Contact with capacitance detection dielectric Film 272

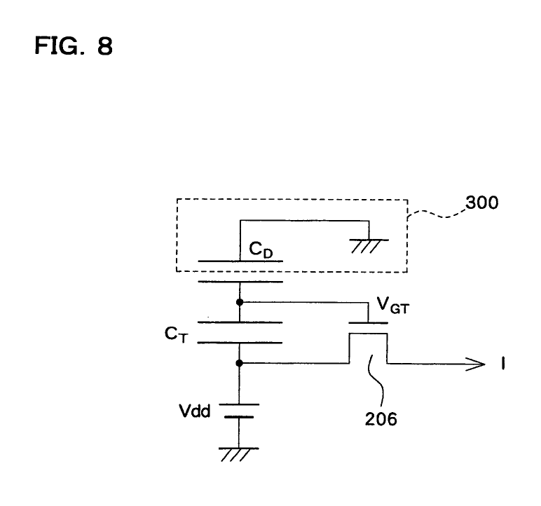

FIG. 8 shows an equivalent circuit of the capacitance detection element 204 in this case. A symbol 300 corresponds to a ridge of a human fingerprint. A grounding electrode 300 which faces the capacitance detection electrode 270 shown in FIG. 7 with the dielectric film 272 interposed therebetween is formed in a region indicated by the symbol 300. A power supply voltage Vdd is supplied from the common power supply line 212. A symbol C_{T} indicates a transistor capacitor of the signal amplification TFT 206. A symbol C_{D} indicates a capacitor between the detection electrode 270 and the grounding electrode (finger) 300.

The length of the gate electrode of the signal amplification TFT 206 is referred to as L (μm), the width of the gate electrode is referred to as W (μm), the thickness of the gate insulating film is referred to as tox (μm), the relative dielectric constant of the gate insulating film is referred to as εox, and the dielectric constant under vacuum is referred to as εo. The capacitance of the transistor capacitor C_{T} is expressed by the following equation (1)

C_{T}=εo·εox·L·W/tox (1)

The area of the capacitance detection electrode 270 is referred to as S (μm²), the thickness of the capacitance detection dielectric film 272 is referred to as td (μm), and the relative dielectric constant of the capacitance detection dielectric film 272 is referred to as εd. The capacitance of the capacitor C_{D} is expressed by the following equation (2).

C_{D}=εo·εd·S/td (2)

In the equivalent circuit shown in FIG. 8, a voltage V_{GT} applied to the gate of the signal amplification TFT 206 is expressed as follows.

V_{GT}=Vdd/(1+C_{D}/C_{T}) (3)

If the capacitance of the capacitor C_{D} is set sufficiently greater than the capacitance of the transistor capacitor C_{T} (C_{D}>10×C_{T}, for example), the denominator in the equation (3) becomes very large, whereby V_{GT} is approximated as follows.

V_{GT}≈0 (4)

As a result, the signal amplification TFT 206 is in an off state since almost no voltage is applied to the gate of the signal amplification TFT 206. Therefore, a current I which flows between the source and the drain of the signal amplification TFT 206 is extremely decreased. The measurement point can be determining to be the ridge (projecting section) of the fingerprint pattern by measuring the current I.

(2) When Valley (Concave Section) of Fingerprint Pattern Faces Capacitance Detection Dielectric Film 272

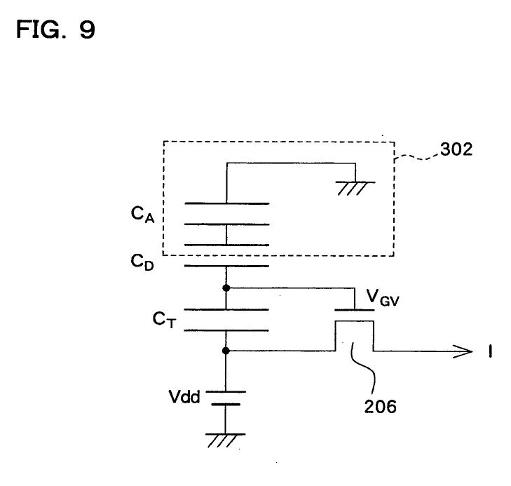

FIG. 9 shows an equivalent circuit of the capacitance detection element 204 in this case. A symbol 302 corresponds to a valley of a human fingerprint. In this case, a capacitor C_{A} having air as a dielectric is formed between the dielectric film 272 and the valley of the fingerprint in addition to the capacitor C_{D} shown in FIG. 8.

In the equivalent circuit shown in FIG. 9, a voltage V_{GV} applied to the gate of the signal amplification TFT 206 is expressed as follows.

V_{GV}=Vdd/{{1+(1/C_{T})}×1/{(1/C_{D})+(1/C_{A})}} (5)

If the capacitance of the capacitor C_{D} is set sufficiently greater than the capacitance of the transistor capacitor C_{T} (C_{D}>10×C_{T}, for example), the equation (5) is approximated as follows.

V_{GV}≈Vdd/[1+(C_{A}/C_{T})] (6)

If the capacitance of the transistor capacitor C_{T} is set sufficiently greater than the capacitance of the capacitor C_{A} formed by the valley of the fingerprint (C_{T}>10×C_{A}, for example), the equation (6) is approximated as follows.

V_{GV}≈Vdd (7)

As a result, the signal amplification TFT 206 is in an on state since the power supply voltage Vdd is applied to the gate of the signal amplification TFT 206. Therefore, the current I which flows between the source and the drain of the signal amplification TFT 206 is extremely increased. Therefore, the measurement point can be determined to be the valley (recess section) of the fingerprint pattern by measuring the current I.

The variable capacitor C_{F} shown in FIG. 6 has a capacitance equal to the capacitance of the capacitor C_{D} when the ridge of the fingerprint is in contact with the capacitance detection dielectric film 272, and has a capacitance equal to the sum of the capacitance of the capacitor C_{D} and the capacitance of the capacitor C_{A} when the valley of the fingerprint faces the capacitance detection dielectric film 272. Therefore, the capacitance of the variable capacitor C_{F} varies corresponding to the ridge and valley of the fingerprint. The ridge or valley of the fingerprint can be detected by detecting the current based on the change in capacitance corresponding to the ridge and valley of the fingerprint.

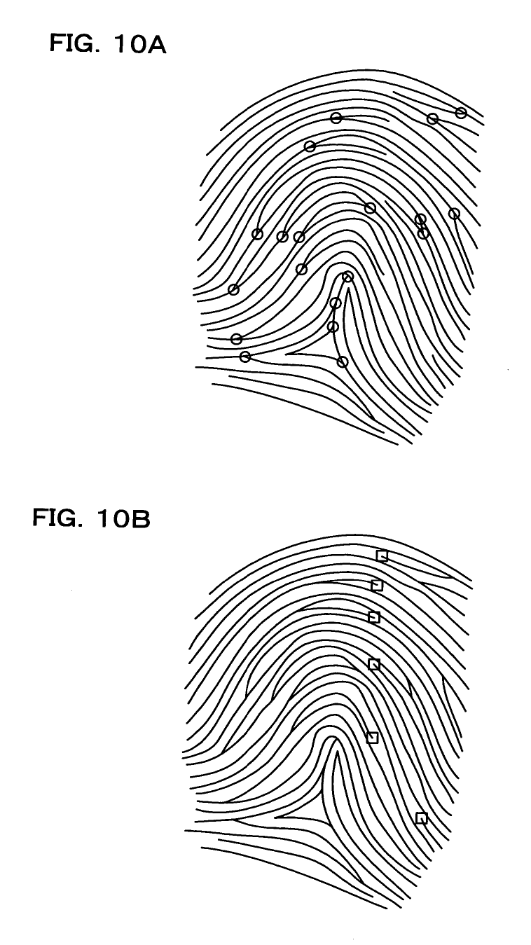

A fingerprint pattern can be detected by carrying out the above-described operation in each of the M×N capacitance detection elements 204 by time division. In more detail, the ridge or valley of the fingerprint is sequentially detected in the capacitance detection elements located in each column in the first row, and the ridge or valley of the fingerprint is then detected in the second row. The ridge or valley of the fingerprint is detected in pixel units in this manner. This enables a fingerprint image as shown in FIGS. 10A and 10B to be obtained, for example. In the this embodiment, fingerprint images are periodically captured by using the fingerprint sensor 132.

In the case where a positive power supply is used as the power supply voltage Vdd, the signal amplification TFT 206 may be formed by using an enhancement N-type transistor in which a drain current does not flow at a gate voltage of about zero. Provided that the gate voltage at which the drain current is minimum (minimum gate voltage) in the transfer characteristics of the signal amplification TFT 206 is Vmin, C_{D}>10×C_{T} is satisfied by satisfying 0<Vmin<0.1×Vdd.

In the case where a negative power supply is used as the power supply voltage Vdd, the signal amplification TFT 206 may be formed by using an enhancement P-type transistor in which a drain current does not flow at a gate voltage of about zero. Provided that the gate voltage at which the drain current is minimum (minimum gate voltage) in the transfer characteristics of the signal amplification TFT 206 is Vmin, C_{D}>10×C_{T} is satisfied by satisfying 0.1×Vdd<Vmin<0.

In the this embodiment, the control information is output by using the captured fingerprint image in this manner. In this case, the processing load can be reduced while maintaining security protection by detecting the movement by using the feature point of the fingerprint image after determining whether or not the captured fingerprint image is the fingerprint image of the registered person by using the feature points of the fingerprint image.

FIGS. 10A and 10B show examples of feature points of the fingerprint. FIG. 10A shows an example of bifurcations of the fingerprint. FIG. 10B shows an example of ending points of the fingerprint. The bifurcations of the fingerprint are extracted from the fingerprint image captured by the fingerprint sensor 132, for example. In FIGS. 10A and 10B, the fingerprint image shows the pattern of ridges (projecting sections) of the fingerprint. The bifurcation of the fingerprint is a portion at which the ridge of the fingerprint branches off into two or more ridges. The ending point of the fingerprint is a portion at which the ridge of the fingerprint ends.

Since the patterns of the fingerprints are not identical, the distribution of the bifurcations or the ending points of the fingerprint differs between individuals. Therefore, if the bifurcations or the ending points of the fingerprint image can be determined, it suffices to merely compare the distribution of the bifurcations or the ending points. This reduces the amount of information to be compared, whereby the load of comparison processing can be reduced.

1.2 Operation Flow

The processing of the input device 120 using the above-described fingerprint sensor is described below. The following description illustrates the case of assigning the feature point information of the fingerprint images of each finger of the user to the parameter type. In this case, the user can output the control information (operation information) by moving the finger assigned to the direction in which it is desired to issue the control instruction on the fingerprint sensor in a predetermined direction.

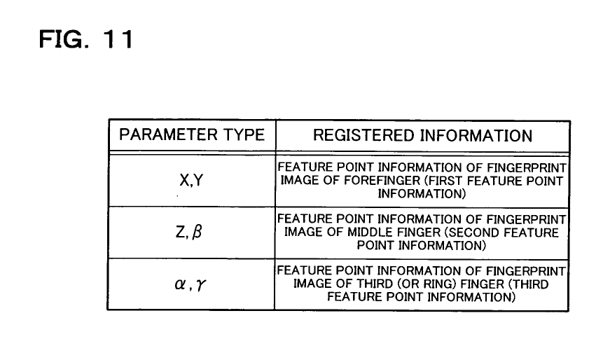

FIG. 11 shows an example of the registration content of the registered information. The feature point information (first feature point information; first registered information in FIG. 2) of the fingerprint image of the forefinger (first finger) of the user (first user) is registered while being assigned to parameter types X and Y (first parameter in FIG. 2; first parameter types). The parameter types X and Y are parameters in two axis (first axis and second axis) directions which intersect at right angles specified on the sensor surface shown in FIG. 3. Therefore, the user who has registered the fingerprint image of the forefinger can generate the control information in the X axis direction or in the Y axis direction corresponding to the moving amount of the forefinger by moving the forefinger pressed against the sensor surface of the fingerprint sensor having the configuration shown in FIG. 4 and FIGS. 6 to 9 in a predetermined direction. This means that a person other than the actual person who has registered the fingerprint image of the forefinger cannot generate the control information. This improves security protection of the information device to which the input device in the this embodiment using the fingerprint sensor is applied.

The feature point information (second feature point information; second registered information in FIG. 2) of the fingerprint image of the middle finger (second finger) of the user (first user) is registered while being assigned to parameter types Z and β (second parameter in FIG. 2; second parameter types). The parameter type Z is a parameter in the direction of the axis (third axis) perpendicular to the sensor surface shown in FIG. 3. The parameter type β is a parameter in the rotation direction around the Z axis. Therefore, the user who has registered the fingerprint image of the middle finger can generate the control information in the Z axis direction or the rotation direction around the Z axis corresponding to the moving amount of the middle finger by moving the middle finger pressed against the sensor surface of the fingerprint sensor having the configuration shown in FIG. 4 and FIGS. 6 to 9 in a predetermined direction. This means that a person other than the actual person who has registered the fingerprint image of the middle finger cannot generate the control information, thereby contributing to improvement of security protection.

The feature point information of the fingerprint image of the third (or ring) finger (third feature point information; third registered information in FIG. 2) is registered while being assigned to parameter types α and β (third parameter in FIG. 2). The parameter type α is a parameter in the rotation direction around the X axis on the sensor surface shown in FIG. 3. The parameter type γ is a parameter in the rotation direction around the Y axis on the sensor surface shown in FIG. 3. Therefore, the user who has registered the fingerprint image of the third finger (or ring finger) can generate the control information in the rotation direction around the X axis or the rotation direction around the Y axis corresponding to the moving amount of the third finger by moving the third finger pressed against the sensor surface of the fingerprint sensor having the configuration shown in FIG. 4 and FIGS. 6 to 9 in a predetermined direction. This means that a person other than the actual person who has registered the fingerprint image of the third finger cannot generate the control information, thereby contributing to improvement of security protection.

The input device verifies the person who has registered the registered information by using the registered information registered in advance as shown in FIG. 11, and outputs the control information corresponding to the parameter type associated with the registered information in advance only in the case where the user is verified. Therefore, the input device using the fingerprint sensor can be applied to a portable information device such as an IC card due to reduction of the size and weight to a large extent. Moreover, since the control instruction in the six-axis directions can be issued merely by moving the finger on the fingerprint sensor, operability can be further improved. Furthermore, since a person other than the registered person cannot generate the control information, security protection of the information device to which the input device is applied can be improved.

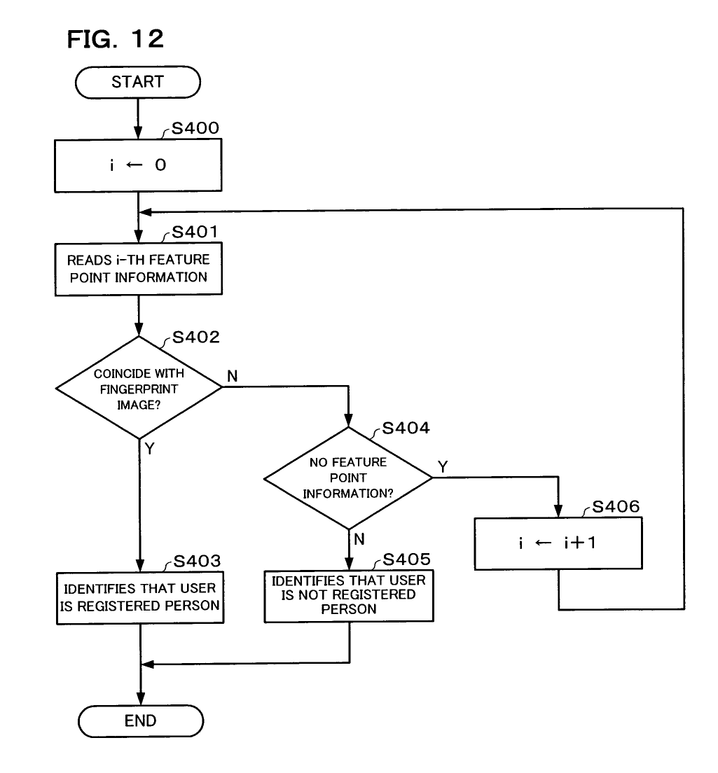

FIG. 12 shows an example of an verification processing flow of the input device in the this embodiment. A program for executing the processing shown in FIG. 12 is stored in the ROM 126 or RAM 128 shown in FIG. 5. The CPU 124 performs the processing according to the program.

The CPU 124 initializes a variable i (i is a natural number) (step S400).

The CPU 124 reads the i-th feature point information (i-th registered information in a broad sense) from the registered information stored in a recording medium such as the RAM 128 shown in FIG. 5 (step S401).

The CPU 124 compares the i-th feature point information with the fingerprint image captured by the fingerprint sensor 132 (step S402). The CPU 124 extracts the feature points of the captured fingerprint image, and compares the feature points of the extracted fingerprint image with the i-th feature point information to determine whether or not the positions of each feature point or distribution of the feature points coincide with the i-th feature point information within a given error range. When it is determined that the captured fingerprint image is the fingerprint image of the person who has registered the i-th feature point information (step S402: Y), the CPU 124 identifies that the user is the registered person (step S403) and terminates the verification processing while displaying the determination result (END).

When it is determined that the captured fingerprint image is not the fingerprint image of the person who has registered the i-th feature point information (step S402: N), the CPU 124 determines whether or not the next feature point information exists in order to continue the verification processing (step S404).

When it is determined that the next feature point information does not exist (step S404: N), the CPU 124 identifies that the user is not the registered person (step S405), and terminates the verification processing while displaying the determination result (END). In this case, since the control information is not generated, a person other than the registered person cannot issue the control instruction.

When it is determined that the next feature point information exists in the step S404 (step S404: Y), the CPU 124 increments the variable i (step S406), returns to the step S401, and reads the i-th feature point information.

As described above, the registered information is searched for the captured fingerprint image, and the control information is output only in the case where it is determined that the captured fingerprint image is the fingerprint image of the registered person.

The input device in the this embodiment outputs the control information by performing the following processing in response to the verification result that the captured fingerprint image is the fingerprint image of the registered person.

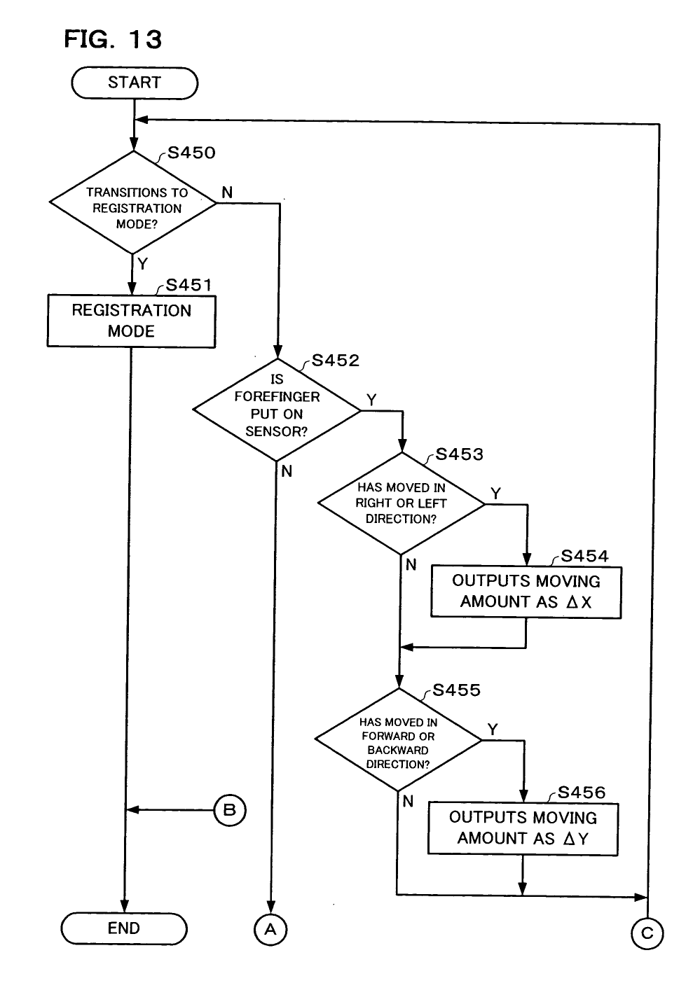

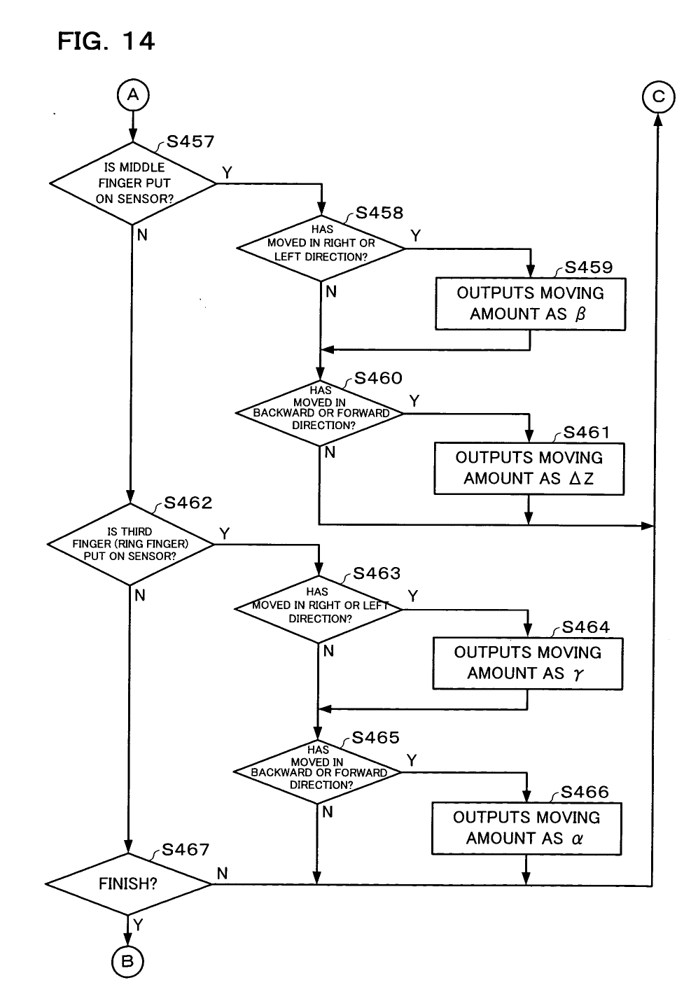

FIGS. 13 and 14 show an example of a control information generation flow of the input device in the this embodiment. A program for executing the processing shown in FIGS. 13 and 14 is stored in the ROM 126 or RAM 128. The CPU 124 performs the processing according to the program.

The input device determines whether or not transition to a registration mode is instructed (step S450).

For example, if the user instructs transition to the registration mode (step S450: Y), the input device transitions to the registration mode (step S451). The registration mode is a mode in which the registration processing of the registered information is performed corresponding to the parameter type as shown in FIG. 11.

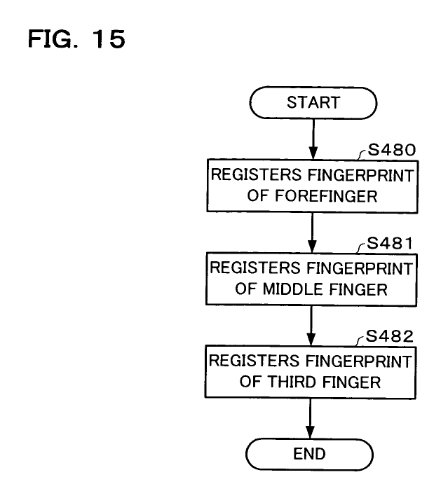

FIG. 15 shows an example of the registration processing in the registration mode. In this case, a program for executing the processing shown in FIG. 15 is stored in the ROM 126 or RAM 128 shown in FIG. 5. The CPU 124 performs the processing according to the program.

In the registration mode, the registration processing of the fingerprint of the user to be captured is performed. In the registration processing, the feature points of the registered fingerprint image are extracted, and the feature point information as shown in FIG. 11 is registered as the registered information corresponding to the parameter type.

In the input device, an image is registered for each output parameter. The following description illustrates the case where the control information is generated by using the fingerprint of the forefinger for X and Y, the fingerprint of the middle finger for β and Z, and the fingerprint of the third finger for α and γ.

The input device registers an image for X and Y as the output parameters. For example, the input device registers the fingerprint of the forefinger of the user (step S480). If the user presses the forefinger against the sensor surface (detection surface) of the fingerprint sensor 132, the image of the fingerprint in contact with the sensor surface is captured. The CPU 124 allows the fingerprint sensor 132 to capture the fingerprint image through the fingerprint sensor I/F circuit 130, and extracts the feature points of the captured fingerprint image. The CPU 124 registers the feature point information on the positions of the extracted feature points or distribution of the feature points as the registered information in the RAM 128 which functions as the registered information storage section 40 corresponding to the parameter types X and Y.

The input device registers an image for β and Z as the output parameters. For example, the input device registers the fingerprint of the middle finger of the user (step S481). If the user presses the middle finger against the sensor surface of the fingerprint sensor 132, an image of the fingerprint in contact with the sensor surface is captured. The CPU 124 allows the fingerprint sensor 132 to capture the fingerprint image through the fingerprint sensor I/F circuit 130, and extracts the feature points of the captured fingerprint image. The CPU 124 registers the feature point information on the positions of the extracted feature points or distribution of the feature points as the registered information in the RAM 128 corresponding to the parameter types Z and β.

The input device registers an image for α and γ as the output parameters. For example, the input device registers the fingerprint of the third finger of the user (step S482). If the user presses the third finger against the sensor surface of the fingerprint sensor 132, an image of the fingerprint in contact with the sensor surface is captured. The CPU 124 allows the fingerprint sensor 132 to capture the fingerprint image through the fingerprint sensor I/F circuit 130, and extracts the feature points of the captured fingerprint image. The CPU 124 registers the feature point information on the positions of the extracted feature points or distribution of the feature points as the registered information in the RAM 128 corresponding to the parameter types α and γ.

The registration processing is then terminated (END).

In FIG. 15, the fingerprints are registered in the order of the forefinger, the middle finger, and the third finger. However, the fingerprint of one finger or the fingerprints of four or more fingers may be registered on instruction from the user. Moreover, the order of registration may be arbitrarily changed. Furthermore, the parameter type to be assigned may be specified each time the fingerprint is registered. The registered information maybe stored in a nonvolatile recording medium such as an EEPROM. The registered information may be stored in an external recording medium through the interface circuit 130.

The description is given with reference to FIG. 13. When it is determined that transition to the registration mode is not instructed in the step S450 (step S450: N), whether or not the forefinger is put on the sensor is determined on condition that the user is identified to be the registered person in the verification processing shown in FIG. 12 (step S452). Specifically, whether or not the forefinger of the registered person is put on the sensor is detected. For example, the CPU 124 may extract the feature points of the fingerprint image captured by the fingerprint sensor, and determine that the forefinger corresponding to the first feature point information is put on the sensor if the extracted feature points coincide with the first feature point information within a given error range in the verification processing shown in FIG. 12.

When it is determined that the forefinger of the registered person is put on the sensor (step S452: Y), the CPU 124 determines whether or not the forefinger is moved in the right or left (X axis) direction (step S453). In this case, the CPU 124 detects the distance at which the position of the captured fingerprint image of the forefinger in the detection area of the fingerprint sensor is moved in the X axis direction with respect to a reference position in the detection area of the fingerprint sensor, for example.

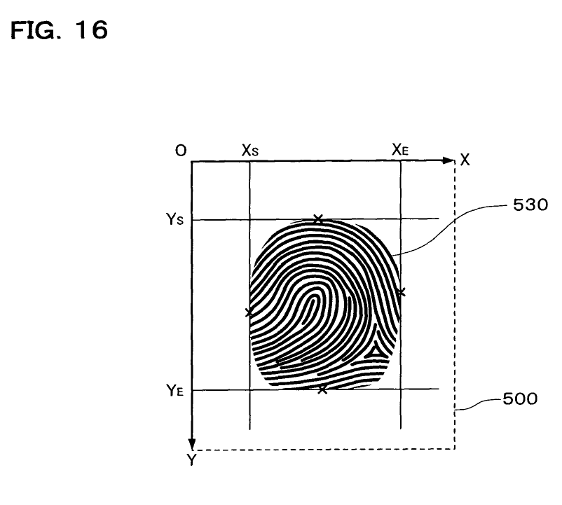

FIG. 16 is illustrative of a method of specifying the position of the fingerprint image in the detection area of the fingerprint sensor. The following description is given on the assumption that the fingerprint sensor 132 scans the fingerprint in the detection area 500 in the X axis direction and the Y axis direction, and a fingerprint image 530 is captured at a position shown in FIG. 16. The maximum value and the minimum value of the outline of the fingerprint image 530 in the X axis direction are referred to as X_{E} and X_{S}, and the maximum value and the minimum value of the outline of the fingerprint image 530 in the Y axis direction are referred to as Y_{E} and Y_{S}. The position (X, Y) of the fingerprint image in the detection area 500 for detecting the movement of the X axis direction shown in FIG. 13 may be (X_{S}, Y_{S}), (X_{E}, Y_{E}), or ((X_{S}+X_{E})/2, (Y_{S}+Y_{E})/2), for example. The position of the captured fingerprint image in the X axis direction and the Y axis direction can be specified by using any of these methods.

Therefore, the moving amount of the fingerprint image can be calculated by comparing the position of the fingerprint image in the X axis direction and the Y axis direction with the reference position in the detection area 500.

In the step S453, the CPU 124 may calculate the movement of the forefinger in the right or left direction by comparing the feature points of the fingerprint images of the forefinger periodically captured by the fingerprint sensor between two frames, and detecting the distance at which the corresponding feature point is moved in the X axis direction.

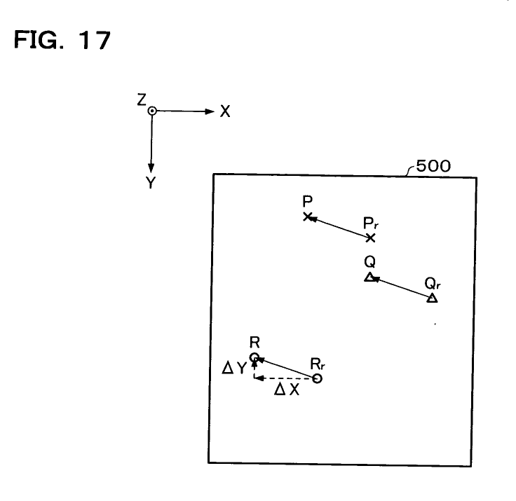

FIG. 17 shows the movement detection principle using the feature points of the fingerprint image. In FIG. 17, feature points Pᵣ, Qᵣ, and Rᵣ extracted from the fingerprint image of the forefinger captured in a frame f are moved to positions of feature points P, Q, and R of the fingerprint image of the forefinger captured in a frame (f+n) (n is a natural number). The CPU 124 moves the fingerprint image in the X axis direction and the Y axis direction so that at least the feature points Pᵣ, Qᵣ, and Rᵣ among three or more extracted feature points respectively coincide with the corresponding feature points P, Q, and R, and detects the deviation as ΔX and ΔY.

When it is determined that the forefinger is moved on the sensor in the right or left direction (step S453: Y), the CPU 124 outputs (or generates) the control information ΔX corresponding to the detected moving amount corresponding to the parameter type X which corresponds to the detected movement in the X axis direction among the parameter types X and Y stored while being associated with the registered information of the forefinger (step S454).

When it is determined that the forefinger is not moved on the sensor in the right or left direction (step S453: N), or if the control information ΔX is output in the step S454, the CPU 124 determines whether or not the forefinger is moved in backward or forward (Y axis) direction (step S455).

When it is determined that the forefinger is moved on the sensor in the backward or forward direction (step S455: Y), the CPU 124 outputs (or generates) the control information ΔY corresponding to the detected moving amount corresponding to the parameter type Y which corresponds to the detected movement in the Y axis direction among the parameter types X and Y stored while being associated with the registered information of the forefinger (step S456). The movement in the Y axis direction can be detected according to the same principle as in the X axis direction.

When it is determined that the forefinger is not moved on the sensor in the backward or forward direction in the step S455 (step S455: N), or if the control information ΔY is output in the step S456, the operation is returned to the step S450.

When it is determined that the forefinger of the registered person is not put on the sensor in the step S452 shown in FIG. 13 (step S452: N), the CPU 124 determines whether or not the middle finger of the registered person is put on the sensor (step S457). For example, the CPU 124 may extract the feature points of the fingerprint image captured by the fingerprint sensor, and determine that the middle finger corresponding to the second feature point information is put on the sensor if the feature points coincide with the second feature point information within a given error range in the verification processing shown in FIG. 12.

When it is determined that the middle finger of the registered person is put on the sensor (step S457: Y), the CPU 124 determines whether or not the middle finger is moved in the right or left (X axis) direction (step S458). The CPU 124 may detect the movement in the X axis direction in the same manner as in the step S453.

When it is determined that the middle finger is moved on the sensor in the right or left direction (step S458: Y), the CPU 124 outputs (or generates) the control information β corresponding to the detected moving amount corresponding to the parameter type β which corresponds to the detected movement in the X axis direction among the parameter types Z and β stored while being associated with the registered information of the middle finger (step S459).

When it is determined that the middle finger is not moved on the sensor in the right or left direction in the step S458 (step S458: N), or if the control information β is output in the step S459, the CPU 124 determines whether or not the middle finger is moved in the vertical (Y axis) direction (step S460)

When it is determined that the middle finger is moved on the sensor in the backward or forward direction (step S460: Y), the CPU 124 outputs (or generates) the control information ΔZ corresponding to the detected moving amount corresponding to the parameter type Z which corresponds to the detected movement in the X axis direction among the parameter types Z and P stored while being associated with the registered information of the middle finger (step S461). The movement in the Y axis direction can be detected according to the same principle as in the X axis direction.

When it is determined that the middle finger is not moved on the sensor in the backward or forward direction in the step S460 (step S460: N), or if the control information ΔY is output in the step S461, the operation is returned to the step S450.

When it is determined that the middle finger of the registered person is not put on the sensor in the step S457 (step S457: N), the CPU 124 determines whether or not the third finger of the registered person is put on the sensor (step S462). For example, the CPU 124 may extract the feature points of the fingerprint image captured by the fingerprint sensor, and determine that the third finger corresponding to the third feature point information is put on the sensor if the feature points coincide with the third feature point information within a given error range in the verification processing shown in FIG. 12.

When it is determined that the third finger of the registered person is put on the sensor (step S462: Y), the CPU 124 determines whether or not the third finger is moved in the right or left (X axis) direction (step S463). The CPU 124 may detect the movement in the X axis direction in the same manner as in the step S453.

When it is determined that the third finger is moved on the sensor in the right or left direction (step S463: Y), the CPU 124 outputs (or generates) the control information γ corresponding to the detected moving amount corresponding to the parameter type γ which corresponds to the detected movement in the X axis direction among the parameter types α and γ stored while being associated with the registered information of the third finger (step S464).

When it is determined that the third finger is not moved on the sensor in the right or left direction in the step S463 (step S463: N), or if the control information γ is output in the step S464, the CPU 124 determines whether or not the third finger is moved in the vertical (Y axis) direction (step S465).

When it is determined that the third finger is moved on the sensor in the backward or forward direction (step S465: Y), the CPU 124 outputs (or generates) the control information α corresponding to the detected moving amount corresponding to the parameter type α which corresponds to the detected movement in the Y axis direction among the parameter types α and γ stored while being associated with the registered information of the third finger (step S466). The movement in the Y axis direction can be detected according to the same principle as in the X axis direction.

When it is determined that the third finger is not moved on the sensor in the backward or forward direction in the step S465 (step S465: N), or if the control information α is output in the step S466, the operation is returned to the step S450.

When it is determined that the third finger of the registered person is not put on the sensor in the step S462 (step S462: N), if the operation is finished (step S467: Y), the processing is terminated (END). If the operation is not finished in the step S467 (step S467: N), the operation is returned to the step S450.

As described above, the control information corresponding to the parameter type associated with the registered information corresponding to the movement of the fingerprint image is output by using the fingerprint image which is determined to be the fingerprint image of the registered person based on the registered information (feature point information).

The above-described embodiment illustrates the case where the movement of the image is detected by using the feature points of the image. However, the present invention is not limited thereto. The movement of the image may also be detected by using the center of gravity of the image.

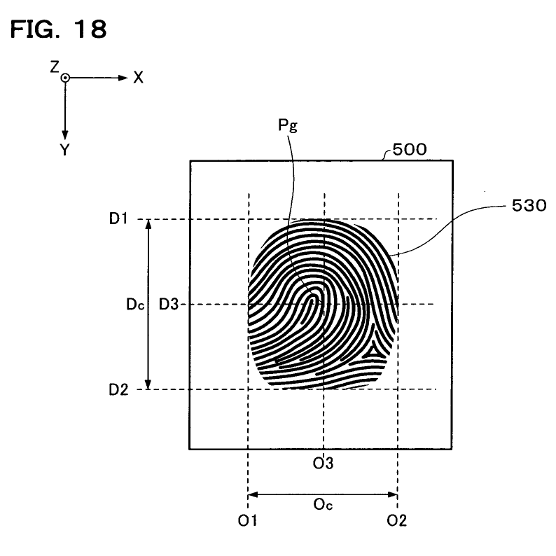

FIG. 18 is illustrative of the center of gravity of the fingerprint image. In this example, the fingerprint sensor having the configuration shown in FIGS. 6 to 9 is used. When the fingerprint sensor 132 captures the fingerprint image 530 in the detection area 500, the number Oc of output lines through which the ridge or valley of the fingerprint is detected can be specified in the X axis direction by an output line O1 at which detection of the ridge or valley of the fingerprint is started and an output line O2 at which the ridge or valley of the fingerprint is detected last. The number Dc of power supply lines through which the ridge or valley of the fingerprint is detected can be specified in the Y axis direction by a power supply line D1 at which detection of the ridge or valley of the fingerprint is started and a power supply line D2 at which the ridge or valley of the fingerprint is detected last. Therefore, a value equivalent to the area of the fingerprint image 530 can be calculated by the number Oc of output lines and the number Dc of power supply lines. Therefore, the center of gravity Pg of the fingerprint image 530 can be calculated while reducing the processing load by specifying a power supply line D3 located almost at an intermediate point between the power supply line D1 and the power supply line D2 and specifying a power supply line O3 located almost at an intermediate point between the power supply line Ol and the power supply line O2.

The above embodiment illustrates the case where the feature point information of the fingerprint image is assigned to the parameter type for each finger of the single user. However, the present invention is not limited thereto. For example, the registered information of one or more fingerprint images may be assigned to the parameter type for each of a plurality of different users. In this case, since only the control information in the control direction corresponding to the parameter type registered in advance can be generated for each user, an input device which maintains security protection can be provided even in the case where the input device is applied to an information device used by a plurality of users.

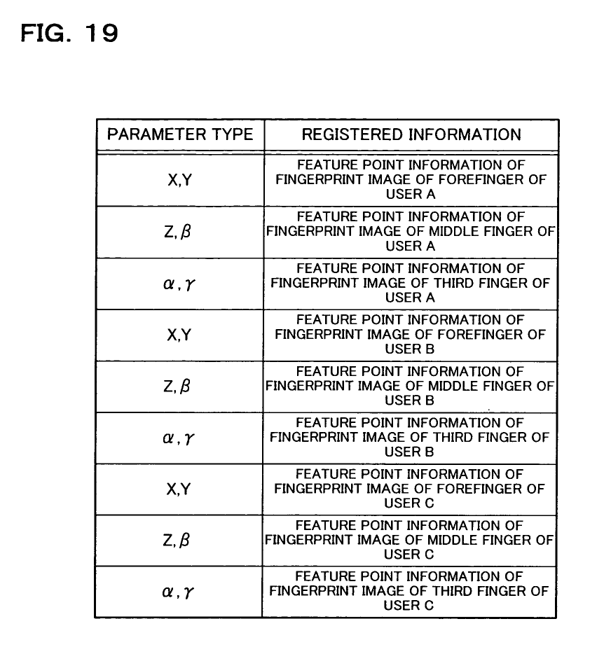

FIG. 19 shows another example of the registration content of the registered information. Specifically, the feature point information of the fingerprint image of the forefinger (first finger) of a user A (first user) is registered while being assigned to the parameter types X and Y (first parameter types) Therefore, the user A can generate the control information in the X axis direction or the Y axis direction corresponding to the moving amount of the forefinger by moving the forefinger pressed against the sensor surface of the fingerprint sensor having the configuration shown in FIG. 4 and FIGS. 6 to 9 in a predetermined direction. This means that a user other than the user A cannot generate the control information.

The feature point information of the fingerprint image of the middle finger (third finger) of a user B (second user) other than the user A is registered while being assigned to the parameter types Z and β (third parameter types). Therefore, the user B can generate the control information in the Z axis direction or the rotational direction around the Z axis corresponding to the moving amount of the middle finger by moving the middle finger pressed against the sensor surface of the fingerprint sensor having the configuration shown in FIG. 4 and FIGS. 6 to 9 in a predetermined direction. This means that a user other than the user B, such as the user A, cannot generate the control information, thereby contributing to improvement of security protection.

The feature point information of the fingerprint image of the third finger of a user C is registered while being assigned to parameter types α and γ. Therefore, the user C can generate the control information in the rotational direction around the X axis or the Y axis corresponding to the moving amount of the third finger by moving the third finger pressed against the sensor surface of the fingerprint sensor having the configuration shown in FIG. 4 and FIGS. 6 to 9 in a predetermined direction.

As described above, the plurality of users cannot generate the control information without using the finger each user has registered, thereby contributing to improvement of security protection.

As shown in FIG. 19, each of the users may register a plurality of fingers. The user may register each finger corresponding to different parameter types.

In FIGS. 13 and 14, the type of the control information generated when moving each finger in the right or left direction or the backward or forward direction is fixed. However, the present invention is not limited thereto. A configuration in which the user can specify the type of the control information to be generated may also be employed. In this case, the control information ΔY may be generated when the user moves the forefinger on the sensor in the right or left direction in FIG. 13, and the control information ΔX may be generated when the user moves the forefinger in the backward or forward direction, for example. The type of the control information to be generated may be specified while being associated with the registered information shown in FIG. 11 or 19.

2. Information Device

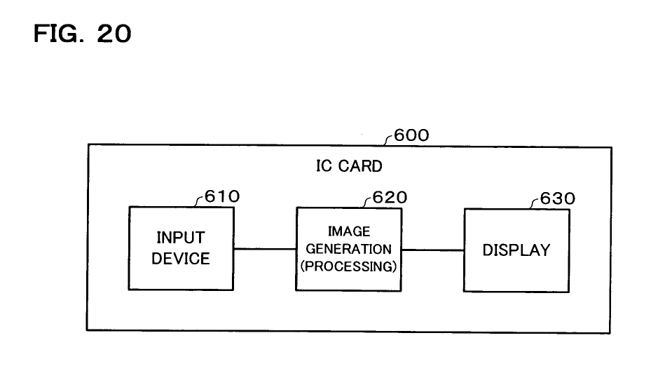

FIG. 20 shows an example of a configuration block diagram of an IC card to which the input device in the this embodiment is applied. An IC card 600 includes an input device 610 using the above-described fingerprint sensor, an image generation section (processing section which performs control processing of a predetermined object of control in a broad sense) 620, and a display section 630. The input device 610 is the input device described with reference to FIG. 1 or 5. The image generation section 620 is realized by a CPU and a software program stored in a ROM or RAM. The display section 630 is realized by an LCD panel and a driver circuit of the LCD panel.

The image generation section 620 generates image data (performs control processing in a broad sense) based on the control information output from the input device 610. In more detail, the image generation section 620 generates image data of an image which is changed corresponding to the movement instruction in the six-axis directions by the input device 610. The display section 630 displays an image based on the image data generated by the image generation section 620.

In the IC card 600 having such a configuration, a pointer displayed in the display section 630 can be moved or an image displayed in the display section 630 can be scrolled by allowing the user to instruct the movement by moving the fingerprint image of the finger in the six-axis directions in the input device 600.

The above description illustrates the case where the IC card is used as an information device. However, the input device according to the this embodiment may be applied to a PDA, a portable telephone, a three-dimensional CAD device, a virtual reality experience device, an electronic musical instrument, or the like.

The present invention is not limited to the above-described embodiment. Various modifications and variations are possible within the spirit and scope of the present invention.

The above embodiment illustrates the input device using the fingerprint sensor. However, the present invention is not limited thereto. The control information may be output in the same manner as described above by capturing an image of a two-dimensional or three-dimensional object other than a fingerprint. The present invention may also be applied to an input device which does not include a detection surface.

Part of requirements of any claim of the present invention could be omitted from a dependent claim which depends on that claim. Moreover, part of requirements of any independent claim of the present invention could be made to depend on any other independent claim.

The following items are disclosed relating to the above-described embodiment.

One embodiment of the present invention relates to an input device comprising:

an image capture section which captures an image of a detection object;

an image comparison section which compares the image of the detection object captured by the image capture section with registered information;

a movement detection section which detects movement of the detection object by using the image of the detection object when it is determined that the registered information includes information corresponding to the image of the detection object according to a result of comparison by the image comparison section; and

a control information output section which outputs control information corresponding to a parameter type associated with the registered information corresponding to the image of the detection object based on a detection result of the movement detection section.

The registered information may be input from the outside.

In this embodiment, when it is determined whether or not the registered information includes information corresponding to the image of the detection object captured by the image capture section according to the comparison result by the image comparison section, the movement of the detection object is detected by using the image of the detection object. The control information corresponding to the parameter type associated with the registered information corresponding to the image of the detection object is output corresponding to the detection result of the movement of the detection object. This prevents a person other than the registered person from generating the control information, whereby security protection can be improved.

Another embodiment of the present invention relates to an input device comprising:

a registered information storage section which-stores registered information corresponding to a parameter type;

an image capture section which captures an image of a detection object;

an image comparison section which compares the image of the detection object captured by the image capture section with the registered information stored in the registered information storage section;

a movement detection section which detects movement of the detection object by using the image of the detection object when it is determined that the registered information storage section stores the registered information corresponding to the image of the detection object according to a result of comparison by the image comparison section; and

a control information output section which outputs control information corresponding to the parameter type associated with the registered information corresponding to the image of the detection object based on a detection result of the movement detection section.

In this embodiment, when it is determined whether or not the registered information corresponding to the image of the detection object captured by the image capture section is stored in the registered information storage section according to the comparison result by the image comparison section, the movement of the detection object is detected by using the image of the detection object. The control information corresponding to the parameter type associated with the registered information corresponding to the image of the detection object is output corresponding to the detection result of the movement of the detection object. This prevents a person other than the registered person from generating the control information, whereby security protection can be improved. Moreover, operability for the user can be improved by appropriately changing the parameter type stored in the registered information storage section.

In any of the input devices according to the above embodiments, the registered information may be a feature point of the image.

In any of the input devices according to the above embodiments, the feature point may be extracted from the image of the detection object captured by the image capture section.

In any of the input devices according to the above embodiments, the movement detection section may detect the movement of the detection object by using the feature point of the image.

In any of the input devices according to the above embodiments, the movement detection section may detect the movement of the detection object by using a center of gravity of the image, and the center of gravity may be calculated from the image of the detection object captured by the image capture section.

According to any of these configurations, the movement of the detection object can be detected by using the image of the detection object while reducing the processing load, and the control information corresponding to the detection result can be generated.

In any of the input devices according to the above embodiments, the image capture section may include a detection surface and may capture the image of the detection being in contact with the detection surface, and

the control information output section may output the control information of at least one of first and second axis directions which intersect each other at right angles on the detection surface, a third axis direction perpendicular to the detection surface, and rotation directions around the first to third axes.

According to any of this configuration, an input device which is capable of further improving operability can be provided.

Any of the input devices according to the above embodiments may comprise a registration section which registers the registered information according to the parameter type.

According to this configuration, since the registered information can be arbitrarily changed, an input device which maintains security protection and is capable of further improving operability by flexibly dealing with the user's peculiar operation can be provided.

In any of the input devices according to the above embodiments, the registered information may include a plurality of pieces of image information, and the parameter type may be associated with each piece of the image information.

According to this configuration, since optimum control information can be output according to the type of the detection object, an information device which is capable of further improving operability can be provided.

In any of the input devices according to the above embodiments, the image of the detection object may be a fingerprint image.

According to this configuration, since a fingerprint sensor which enables further reduction of the size and weight can be used, the input device can be applied to a portable information device.

Another embodiment of the present invention relates to an information device comprising the above input device, and a processing section which performs control processing based on the control information from the input device.

According to this embodiment, a portable information device which is extremely small and lightweight and is capable of further improving operability can be provided.

A further embodiment of the present invention relates to a control information generation method for generating control information by using a captured image of a detection object, the control information generation method comprising:

searching information corresponding to an image of the detection object in registered information stored corresponding to a parameter type by using the image of the detection object;

detecting movement of the detection object by using the image of the detection object when it is determined that the information corresponding to the image of the detection object is included in the registered information and;

generating the control information corresponding to the parameter type associated with the registered information corresponding to the image of the detection object based on a detection result for the movement of the detection object.

This control information generation method may comprise:

generating the control information of at least one of first and second axis directions which intersect each other at right angles on the detection surface, a third axis direction perpendicular to the detection surface, and rotation directions around the first to third axes.

In this control information generation method, the image of the detection object may be a fingerprint image.

What is claimed is:

1. An input device comprising:
an image capture section which captures an image of a detection object;
an image comparison section which compares the image of the detection object captured by the image capture section with registered information;
a movement detection section which detects movement of the detection object by using the image of the detection object when it is determined that the registered information includes information corresponding to the image of the detection object according to a result of comparison by the image comparison section; and
a control information output section which outputs control information corresponding to a parameter type associated with the registered information corresponding to the image of the detection object based on a detection result of the movement detection section.

2. An input device comprising:
a registered information storage section which stores registered information corresponding to a parameter type;
an image capture section which captures an image of a detection object;
an image comparison section which compares the image of the detection object captured by the image capture section with the registered information stored in the registered information storage section;
a movement detection section which detects movement of the detection object by using the image of the detection object when it is determined that the registered information storage section stores the registered information corresponding to the image of the detection object according to a result of comparison by the image comparison section; and
a control information output section which outputs control information corresponding to the parameter type associated with the registered information corresponding to the image of the detection object based on a detection result of the movement detection section.

3. The input device as defined in claim 1,
wherein the registered information is a feature point of the image.

4. The input device as defined in claim 2,
wherein the registered information is a feature point of the image.

5. The input device as defined in claim 3,
wherein the feature point is extracted from the image of the detection object captured by the image capture section.

6. The input device as defined in claim 4,
wherein the feature point is extracted from the image of the detection object captured by the image capture section.

7. The input device as defined in claim 1,
wherein the movement detection section detects the movement of the detection object by using the feature point of the image.

8. The input device as defined in claim 2,
wherein the movement detection section detects the movement of the detection object by using the feature point of the image.

9. The input device as defined in claim 1,
wherein the movement detection section detects the movement of the detection object by using a center of gravity of the image, and
wherein the center of gravity is calculated from the image of the detection object captured by the image capture section.

10. The input device as defined in claim 2,
wherein the movement detection section detects the movement of the detection object by using a center of gravity of the image, and
wherein the center of gravity is calculated from the image of the detection object captured by the image capture section.

11. The input device as defined in claim 1,
wherein the image capture section includes a detection surface and captures the image of the detection being in contact with the detection surface, and
wherein the control information output section outputs the control information of at least one of first and second axis directions which intersect each other at right angles on the detection surface, a third axis direction perpendicular to the detection surface, and rotation directions around the first to third axes.

12. The input device as defined in claim 2,
wherein the image capture section includes a detection surface and captures the image of the detection being in contact with the detection surface, and
wherein the control information output section outputs the control information of at least one of first and second axis directions which intersect each other at right angles on the detection surface, a third axis direction perpendicular to the detection surface, and rotation directions around the first to third axes.

13. The input device as defined in claim 2, comprising:
a registration section which registers the registered information according to the parameter type.

14. The input device as defined in claim 1,
wherein the registered information includes a plurality of pieces of image information, the parameter type being associated with each piece of the image information.

15. The input device as defined in claim 2,
wherein the registered information includes a plurality of pieces of image information, the parameter type being associated with each piece of the image information.

16. The input device as defined in claim 1,
wherein the image of the detection object is a fingerprint image.

17. The input device as defined in claim 2,
wherein the image of the detection object is a fingerprint image.

18. An information device comprising:
the input device as defined in claim 1; and
a processing section which performs control processing based on the control information from the input device.

19. An information device comprising:
the input device as defined in claim 2; and
a processing section which performs control processing based on the control information from the input device.

20. A control information generation method for generating control information by using a captured image of a detection object, the control information generation method comprising:
searching information corresponding to an image of the detection object in registered information stored corresponding to a parameter type by using the image of the detection object;
detecting movement of the detection object by using the image of the detection object when it is determined that the information corresponding to the image of the detection object is included in the registered information and;
generating the control information corresponding to the parameter type associated with the registered information corresponding to the image of the detection object based on a detection result for the movement of the detection object.

21. The control information generation method as defined in claim 20, comprising:
generating the control information of at least one of first and second axis directions which intersect each other at right angles on the detection surface, a third axis direction perpendicular to the detection surface, and rotation directions around the first to third axes.

22. The control information generation method as defined in claim 20,
wherein the image of the detection object is a fingerprint image.

23. The control information generation method as defined in claim 21,
wherein the image of the detection object is a fingerprint image.
